(19) United States
(12) Patent Application Publication
(10) Pub. No.: US 2026/0341553 A1
(43) Pub. Date: Oct. 29, 2026

(54) Superconducting Cable Comprising Solder Channel

(71) Applicants: Massachusetts Institute of Technology, Cambridge, MA (US); Commonwealth Fusion Systems LLC, Devens, MA (US)

(72) Inventors: Amanda HUBBARD, Bedford, MA (US); Christopher J. LAMMI, Lynnfield, MA (US); Christopher CRAIGHILL, Groton, MA (US); Charlie SANABRIA, Shirley, MA (US); Amelia WATTERSON, Cambridge, MA (US)

(73) Assignees: Massachusetts Institute of Technology, Cambridge, MA (US); Commonwealth Fusion Systems LLC, Devens, MA (US)

(21) Appl. No.: 19/122,356

(22) PCT Filed: Oct. 20, 2023
(86) PCT No.: PCT/US2023/077370

§ 371 Date: Apr. 18, 2025

Related U.S. Application Data
(60) Provisional application No. 63/418,087, filed on Oct. 21, 2022.

(51) Int. Cl. H01B 12/10; H01B 1/08; H01B 12/08; H01B 12/16; H01B 13/22; H01B 13/32; H01F 6/06

(52) U.S. Cl. CPC H01B 12/10; H01B 1/08; H01B 12/08; H01B 12/16; H01B 13/22; H01B 13/322; H01F 6/06

(57) ABSTRACT

Techniques are described that allow for HTS cables to be solder-filled more easily, quickly, and with a reduced degradation to the performance of the HTS in the cable. In particular, a channel within an HTS cable may include a primary channel into which the HTS is arranged, in addition to a secondary channel that provides an increased hydraulic cross-section through which the solder can flow. The secondary channel may be connected to the primary channel (e.g., as a side-channel). If the secondary channel has an opening within the primary channel that is smaller than the HTS material being placed in the primary channel, the HTS material is not at risk of moving into the secondary channel, which can provide a space proximate to the HTS material and the primary channel through which the solder can freely flow.

### BACKGROUND

Superconductors are materials that have no electrical resistance to current (are “superconducting”) below some critical temperature. For many superconductors, the critical temperature is below 30 °K, such that operation of these materials in a superconducting state requires significant cooling, such as with liquid helium.

High-field magnets are often constructed from superconductors due to the capability of superconductors to carry a high current without resistance. Such magnets may, for instance, carry currents greater than 5 kA.

### SUMMARY

In some aspects, the structures and techniques described herein relate to a cable including: an electrically conductive structure extending along the cable and including a channel, the channel including a primary channel portion and a side-channel portion connected to and arranged alongside the primary channel portion; a stack of high temperature superconductor (HTS) tapes arranged within the primary channel portion of the channel; and solder arranged within the side-channel portion of the channel and within at least part of the primary channel portion of the channel.

In some aspects, the techniques described herein relate to a method including: at least partially filling a channel of a high temperature superconductor (HTS) cable assembly with a molten metal, the HTS cable assembly including: an electrically conductive structure extending along the HTS cable assembly and including the channel, the channel including a primary channel portion and a side-channel portion connected to and arranged alongside the primary channel portion; and a stack of HTS tapes arranged within the primary channel portion of the channel, wherein at least partially filling the channel of the HTS cable assembly includes directing the molten metal into the side-channel portion of the channel and into the primary channel portion of the channel. In embodiments, the method further includes operating one or more cooling devices to cool the molten metal in one or both of the side-channel portion or the primary channel portion.

In some aspects, the techniques described herein relate to a cable including: an electrically conductive structure extending along the cable and including a channel, the channel including a primary channel portion and a secondary portion; a stack of high temperature superconductor (HTS) tapes arranged within the primary channel portion of the channel; and solder arranged within the secondary portion of the channel and within at least part of the primary channel portion of the channel.

In some aspects, the techniques described herein relate to a cable including: an electrically conductive structure extending along the cable and including a channel, the channel including a primary channel portion; a jacket structure arranged at least partially around the electrically conductive structure, the jacket structure including a side-channel portion connected to and arranged alongside the primary channel portion of the electrically conductive structure; a stack of high temperature superconductor (HTS) tapes arranged within the primary channel portion of the channel; and solder arranged within the side-channel portion of the jacket structure and within at least part of the primary channel portion of the channel.

In some aspects, an HTS cable assembly comprises at least one electrically conductive structure extending along the cable and comprising a primary channel portion and a side-channel portion with an opening between the primary channel portion and side-channel portion such that the primary channel portion and the side-channel portion are in fluid communication; and a stack of high temperature superconductor (HTS) tapes arranged within the primary channel portion with at least a portion of the stack of HTS proximate the opening between the primary channel portion and side-channel portion.

In embodiments, the size of the opening between the primary channel portion and the side-channel portion is selected such that the stack of HTS tapes will not move into the secondary channel.

In embodiments, the HTS cable assembly may further comprise a metal jacket disposed about the electrically conductive structure.

In embodiments, the HTS cable assembly includes a plurality of electrically conductive structures, each of which corresponds to an electrically conductive segment, each of plurality of electrically conductive segments having a shape which defines a primary channel portion and a side-channel portion and each of the primary channel portions has a stack of HTS tapes disposed therein.

In embodiments, the HTS cable assembly may further comprise an insulator disposed between adjacent ones of the plurality of electrically conductive segments, the insulator having a size and shape selected to electrically insulate the plurality of electrically conductive segments from one another.

In embodiments, the plurality of electrically conductive segments in the HTS cable assembly are disposed about a central longitudinal axis of the HTS cable assembly; and the stack of HTS tapes follow a helical path around the central longitudinal axis of the HTS cable assembly.

In embodiments, the HTS cable assembly may further comprise an electrically insulating material arranged between adjacent electrically conductive segments of the plurality of electrically conductive segments that electrically insulates the plurality of electrically conductive segments from one another.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 illustrates a cross-sectional view of an illustrative superconducting cable, according to some embodiments;

FIGS. 2A-2D each depict an electrically conductive segment separately from a cable in which they may be arranged, according to some embodiments;

FIG. 3 depicts a cross-sectional view of an illustrative superconducting cable including a jacket, according to some embodiments;

FIGS. 4A-4B are a flow diagram of a method of metal-filling a superconducting cable, according to some embodiments;

FIG. 5 is a block diagram of a cooling system comprising one or more movable blowers and one or more heaters with a first heater configured to be in thermal contact with a first end of an HTS cable and a second heater configured to be in thermal contact with a second, opposite end of the HTS cable; and

FIG. 6 is a perspective view of a fusion machine having a portion thereof removed (a cutaway portion) to illustrate various internal components of the fusion machine, according to some embodiments.

### DETAILED DESCRIPTION

A high-field superconducting magnet often comprises multiple electrically insulated cable turns grouped in a multi-layer arrangement. When the superconducting material is cold enough to be below its critical temperature (the temperature below which the electrical resistivity of the material drops to zero), driving the magnet allows current to pass through the superconducting path without losses. However, for various reasons some or all of the superconducting material may be heated to above its critical temperature and therefore lose its superconducting characteristics. If uncontrolled, such heating can lead to the superconductor losing its superconducting abilities, often referred to as a “quench.” Moreover, if the quench is not properly addressed by the system (e.g., by shutting down), components can be damaged by the heating.

Some superconducting magnet systems handle quench events via a system of active alarms and detection mechanisms. Other superconducting magnet systems handle quenches passively through design of the superconducting magnet itself. An example of the latter approach is a non-insulated (NI) magnet (also referred to as a no-insulation (NI) magnet), in which adjacent superconducting turns of the magnet are not insulated from one another but are instead separated by a conventional conductor (i.e., not a superconductor). When the magnet is operating below the superconductor's critical temperature, current flows through the superconductor and not across turns because the superconductor has zero resistance compared with the finite resistance of the conductor that lies between the turns.

Some designs of superconducting cables may comprise high temperature superconductor (HTS) material arranged within an electrically conducting structure. For instance, a cable may comprise an electrically conducting structure that supports one or more HTS tapes. The electrically conducting structure, sometimes referred to as a “former,” may include multiple channels into which the HTS tapes are arranged. This arrangement may, however, result in small gaps between the HTS and the former which may lower the ability of the cable to carry current and may increase the susceptibility of the cable to a quench. The cables may be insulated, or may be placed in an electrically conductive supporting structure to produce a non-insulated magnet.

In a so-called Vacuum Pressure Impregnation (VPI) process, one or more HTS magnet structures (e.g., HTS material arranged within an electrically conducting structure), are heated and a molten solder is passed into and through open channels in the structure. The solder may flow into open spaces in the magnet structure, filling them with an electrically conductive material. In some cases, the process may be performed at a comparatively low temperature (e.g., around 200 °C) to allow the solder to flow through the structure.

Exposure to molten solder may erode or otherwise cause damage to HTS tape. For example, exposure to molten solder may erode protective copper cladding around an HTS tape. Thus, in some cases it may be desirable to reduce the duration during which molten solder is in contact with HTS during a VPI process. Moreover, an HTS cable that is twisted prior to a VPI process may be difficult to fill efficiently due to open spaces within the cable around the twisted HTS material, as such spaces may be small relative to the cable diameter. In some cases, the relatively small spaces may become blocked, impeding solder flow.

The techniques described herein allow for HTS cables to be solder-filled more easily, quickly, and with a reduced degradation to the performance of the HTS in the cable than previous techniques.

In particular, a channel within an HTS cable may include a primary channel into which the HTS is arranged, in addition to a secondary channel that provides an increased hydraulic cross-section through which the solder can flow. The secondary channel may be connected to the primary channel (e.g., as a side-channel). If the secondary channel is connected to the primary channel via an opening that is smaller than the HTS material being placed in the primary channel, the HTS material is not at risk of moving into the secondary channel, which can provide a space proximate the HTS material and the primary channel through which the solder can freely flow.

As a result, molten solder may be able to flow into the desired spaces in the cable more efficiently and thus in much less time than previous structures and techniques. As a consequence of this improvement in efficiency (e.g., improvement in flow speed), HTS cables may be fabricated with a given level of degradation which is less than the level of degradation achieved using prior techniques in which HTS cable structures do not include both primary and secondary channels. Furthermore, as a consequence of the improvement in efficiency achieved using the structures and techniques described herein, much longer HTS cables may be fabricated with a given level of degradation (as compared with prior approaches), since the increase in flow speed means that longer flow distances can produce the same amount of degradation of HTS material during solder flow process.

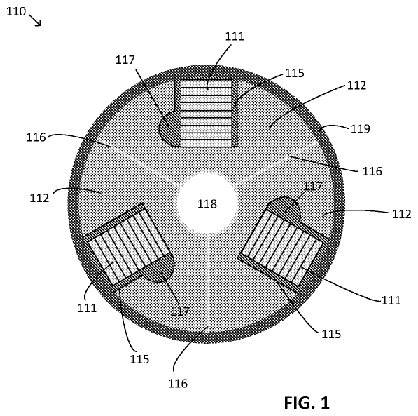

FIG. 1 illustrates a cross-sectional view of an illustrative superconducting cable, according to some embodiments. Although the techniques described herein may be applied to any suitable superconducting cable, FIG. 1 depicts an example of a cable in which three channels containing HTS are formed in three separate electrically conductive segments 112, which are separated from one another by an electrically insulating material 116. The below description may equally apply, for instance, to a cable in which any number of channels are arranged within a single electrically conductive structure (e.g., having a circular cross-section).

In the example of FIG. 1, the electrically conductive segments 112 are configured to hold respective HTS tape stacks 111 within respective channels within each segment. It may be noted that cable 110 may be produced from a plurality of instances, here three instances, of the same electrically conductive segment 112 arranged as shown in FIG. 1. The illustrative cable of FIG. 1 comprises a jacket 119 arranged exterior to the electrically conductive segments. According to some embodiments, jacket 119 may comprise, or may consist of, steel, Inconel®, Nitronic® 40, Nitronic® 50, Incoloy®, or combinations thereof.

In the example of FIG. 1, the HTS tape stacks 111 are arranged in contact with solder 115, which provides at least part of the electrical contact between the HTS tape stacks and each respective electrically conductive segment 112. The solder 115 may comprise any suitable material. For example, solder 115 may comprise, or may consist of, a (lead) Pb and/or (tin) Sn solder. In some embodiments, the solder 115 may comprise a metal having a melting point of less than 200 °C, wherein at least 50% by weight (50 wt %) of the metal is Pb and/or Sn.

As shown in the example of FIG. 1, the channels formed within each of the electrically conductive segments 112 in which the HTS tape stacks 111 and solder 115 are arranged, include a larger, primary channel portion (also sometimes referred to herein as “primary portion”) holding HTS tape stacks (i.e., HTS tape stacks 111 are disposed in respective ones of the primary channel portions), and a smaller, secondary portion 117 (also sometimes referred to herein as a “side-channel portion” or a “secondary portion” or a “secondary channel”) on the side of the primary portion. In the example of FIG. 1, the primary channel portion and side-channel portion are in fluid communication (e.g., are coupled or connected).

As described above, the secondary portion of the channel may provide an avenue or path for solder 115 to pass through during a process of filing the cable with solder. As shown, solder may also be deposited or otherwise disposed along the sides and/or top of the HTS stacks. The solder in the primary and secondary portions of the channel may together form a continuous region of solder.

It is noted that in the absence of the secondary portion of the channel, the space through which the solder must pass may be limited. Thus, inclusion of a secondary portion may increase the hydraulic cross-section for solder flow. Accordingly, inclusion of a secondary portion (e.g., secondary portion 117) in a channel may reduce the amount of time required for solder filling compared with the time required for solder filling when a channel does not include a secondary portion. This may be due, at least in part, to the hydraulic cross-section for solder flow being lower in a channel which does not include a secondary portion as compared the hydraulic cross-section for solder flow in a channel which includes a secondary portion. Upon filling of the primary and secondary portions of a channel, the channel may contain a contiguous region of solder that is arranged within (and preferably entirely fills) both the primary portion and the secondary portion of the channel.

Omission of a secondary portion may thus result in a solder filling time which is increased compared with a solder filling time of a superconducting cable which includes channels having a secondary portion. Longer solder filling times may lead to degradation (or increased degradation) of the HTS material as a result of heat exposure during filling. Thus, inclusion of a secondary portion may result in less (and ideally minimal or no) degradation of the HTS material as a result of heat exposure during filling.

As described above, the opening between the primary portion and the secondary portion 117 of a channel may be smaller than an HTS tape stack 111. Although secondary portions 117 are illustrated in FIG. 1 as being at the bottom of the primary portion, it should be appreciated that secondary portions 117 may be located along any region of the primary portion (including, but not limited to a middle or top region of the primary portion).

During operation of the cable 110, at least the HTS tape stacks 111 are cooled to below their superconducting transition so that they may carry current at zero resistance. The electrically conductive segments 112 act as stabilizers during a quench; when part of the HTS material quenches, heat may be conducted through the electrically conductive segment that supports the quenched superconductor component to the other electrically conductive segments, thereby quenching the whole cross section of the cable. Subsequently, a non-superconducting zone within HTS tape stacks 111 may be created and propagate along the cable.

According to some embodiments, electrically conductive segments 112 may comprise, or may consist of, copper. Copper may represent a desirable material due to its high thermal conductivity, thereby providing a stabilizing function in case of a quench, as well as being electrically conductive. Other suitable materials that electrically conductive segments 112 may comprise, or may consist of, include aluminum.

According to some embodiments, electrically insulating material 116 is arranged to contact different ones of the electrically conductive segments 112 on either side. As shown in FIG. 1, electrically insulating material 116 is arranged between adjacent pairs of the electrically conductive segments 112, and may be arranged so as to contact both segments of the pair (ideally, so as to leave no gaps, or substantially no gaps, between the electrically insulating material 116 and each electrically conductive segment). In some embodiments, the electrically insulating material 116 may be provided in the form of a tape that may be arranged between the pairs of the electrically conductive segments 112. In some cases, the tape may be an adhesive tape and adhered to the adjacent electrically conductive segments 112 via the adhesive so that the tape is adhered to the electrically conductive segments.

According to some embodiments, HTS tape stacks 111 may comprise one or more high temperature superconductors. As used herein, a “high temperature superconductor” or “HTS” refers to a material that has a critical temperature above 30 °K, wherein the critical temperature refers to the temperature below which the electrical resistivity of the material is zero. The critical temperature can in some cases depend on other factors such as the presence of an electromagnetic field. It will be appreciated that where the critical temperature of a material is referred to herein, this may refer to whatever the critical temperature happens to be for that material under the given conditions.

The HTS tape stacks 111 may comprise one or more lengths of HTS tape, which is a long, thin strand of HTS material with cross-sectional dimensions in the range of about 0.001 mm to about 0.1 mm in thickness (or height) and a width in the range of about 1 mm to about 12 mm (and with a length that extends along the length of the cable, i.e., into and out of the page in the example of FIG. 1). In some embodiments, HTS tape may comprise a polycrystalline HTS and/or may have a high level of grain alignment. The HTS tape stacks 111 may comprise a plurality of HTS tapes arranged on top of one another along the width and length directions. An HTS tape stack may thereby have a thickness equal to (or approximately equal to) the thickness of an individual tape multiplied by the number of tapes in the stack.

According to some embodiments, electrically insulating material 116 may comprise polyimide (e.g., Kapton®), epoxy resin, phenolic resin, a plastic, an elastomer, steel (e.g., stainless steel) or combinations thereof. According to some embodiments, insulating material may have a breakdown voltage or dielectric strength of greater than 25 kV/mm, of greater than 50 kV/mm, of greater than 75 kV/mm, of greater than 1000 kV/mm.

In some embodiments, electrically insulating material 116 may comprise, or may consist of, a high-resistivity material that is nonetheless electrically conductive to some extent. In this respect, references to material 116 being “insulating” refers to the fact that the material 116 is much less electrically conductive than the material making up the electrically conductive segments 112. For instance, in some embodiments, the electrically conductive segments 112 may comprise a highly conductive material such as copper, whereas the electrically insulating material 116 may comprise steel, which is not strictly an insulator but is nonetheless far more insulating than copper.

In the example of FIG. 1, the electrically conductive segments 112 may provide mechanical integrity to the cable in addition to the aforementioned advantages with respect to quenching behavior. The electrically conductive segments 112 may be formed into or may conform to a desired shape and may provide a substantial amount of structural strength to the cable. This is in contrast to other superconducting cables such as the Cable in Conduit Conductor (CICC) braided cables, which feature twisted copper rods that can deform under high electromagnetic loads.

According to some embodiments, electrically conductive segments 112 may be twisted along the length of the cable 110. That is, the electrically conductive segments 112 may be twisted around a central longitudinal axis of the cable; as such, the cross-sectional view of FIG. 1 may be accurate at various points along the cable but for the rotational orientation of the view shown, which will rotate about the center of the cable as the cross-sectional view is moved along the length of the cable. A helical path is one example of a twisted path that the electrically conductive segments may follow around the central longitudinal axis of the cable. In such a configuration, the electrically conductive segments 112 may be aligned along respective helical paths with a center of each helix being the central longitudinal axis of the cable. Similarly, the HTS tape stacks 111 may be supported by the electrically conductive segments 112 along the length of the cable in the manner shown in FIG. 1, and thereby also be aligned along respective helical paths with a center of each helix being the central longitudinal axis of the cable. Arranging the HTS tape stacks 111 along twisted paths may reduce the length over which two conductive paths are parallel to one another, and thereby reduce this source of inductive heating.

In the example of FIG. 1, cable 110 comprises central cooling channel 118, which may be a tubular cooling channel that runs along the longitudinal axis of the cable. In general, any number of channels may be formed or otherwise provided through the cable to provide cooling to the electrically conductive segments 112 and/or to the HTS tape stacks 111. Such cooling channels may for instance provide a path for cryogenic liquid such as liquid helium or liquid nitrogen to flow and carry heat away from the electrically conductive segments 112 and/or the HTS tape stacks 111. Coolant may be provided through a cooling channel at a high pressure, such as above 2 bar.

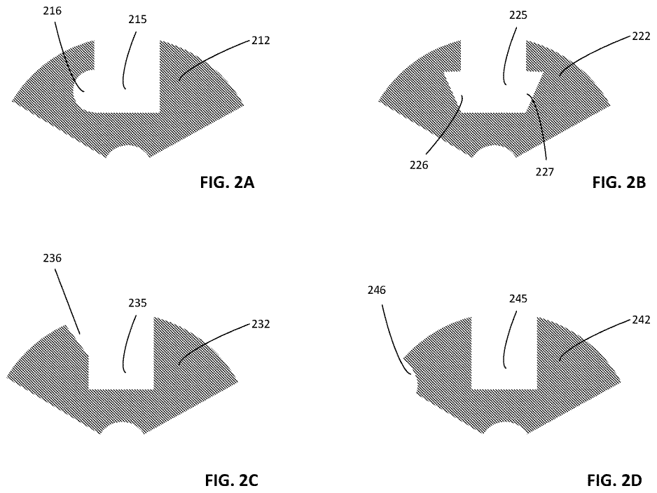

FIGS. 2A-2D each depict an electrically conductive segment separately from a cable in which they may be arranged, according to some embodiments. For instance, electrically conductive segment 212 shown in FIG. 2A, comprising a channel that includes a primary region (or primary channel portion) 215 and a secondary region (or side-channel portion) 216, corresponds to the electrically conductive segments 112 shown in FIG. 1. The secondary region 216 is concave, and has a shape of a half-circle in cross-section.

As described above, a superconducting cable may comprise any number of such segments arranged with insulating material between the segments. In some embodiments, a superconducting cable may comprise a plurality of segments arranged such that the segments exhibit radial symmetry around a central axis of the cable. Alternatively, a superconducting cable may comprise a single electrically conductive structure comprising multiple channels each having any one or more of the channel shapes shown in FIGS. 2A-2D.

In the example of FIG. 2B, electrically conductive segment 222 comprises a channel that includes a primary region (or primary channel portion) 225 and secondary regions (or side-channel portions) 226 and 227, which are wedge-shaped (or ‘flared’) regions arranged on either side of the primary region. In the example of FIG. 2C, electrically conductive segment 232 comprises a channel that includes a primary region (or primary channel portion) 235 and a secondary region (or side-channel portion) 236, which is a wedge-shaped (or ‘flared’) region arranged alongside the primary region at the perimeter of the segment.

In the example of FIG. 2D, electrically conductive segment 242 comprises a first channel (or primary channel portion) 245 and a second channel (or side-channel portion) 246, which are not formed as a contiguous channel, but are instead formed as separate channels within the segment. This approach may have an advantage of reducing the potential impact on the strength of the segment resulting from a larger channel, but may also have a disadvantage that solder is filled further from the HTS material and may not fill this space as readily.

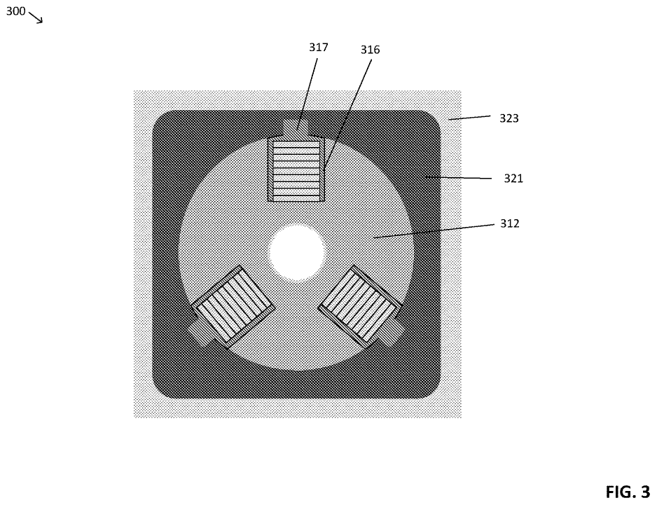

Alternatively to the approaches described above, the secondary region (aka side-channel portion) of the channel could be formed at the top of a primary channel portion in cases where the former is arranged within a jacket structure. This approach is shown in FIG. 3, wherein a cross-sectional views of a superconducting cable 300 is shown. In the example of FIG. 3, the cable comprises a single electrically conductive structure 312 in which the primary portions of three channels are formed. Secondary portions of these channels are formed in a jacket structure 321. For example, a primary portion 316 of one channel is formed in the electrically conductive structure 312, with the secondary portion 317 being formed within the jacket structure 321.

In the example of FIG. 3, jacket structure 321 may for instance be a stainless steel jacket, which is wrapped in a dielectric layer 323 (e.g., a layer of polyimide such as Kapton®, a fiberglass cloth).

In some embodiments, a cable assembly may be wrapped in a dielectric (e.g., fiberglass cloth, polyimide) and then vacuum pressure impregnated to fill the remaining space between the cable turns with a dielectric, such as an epoxy resin. For instance, the cable assembly may be wrapped in a first dielectric, arranged in a number of turns, then vacuum pressure impregnated with epoxy. The epoxy may be cured via thermal means or otherwise.

In some embodiments, a cable assembly may be arranged within a structural matrix. For instance, the jacket may comprise a number of channels in which windings of a cable assembly (or windings of multiple cable assemblies) may be arranged. As such, the jacket may act as a structural support (e.g., structural plate) supporting multiple windings of one or more cable assemblies. Such a jacket may be surrounded by one or more dielectric layers as described above, in some embodiments.

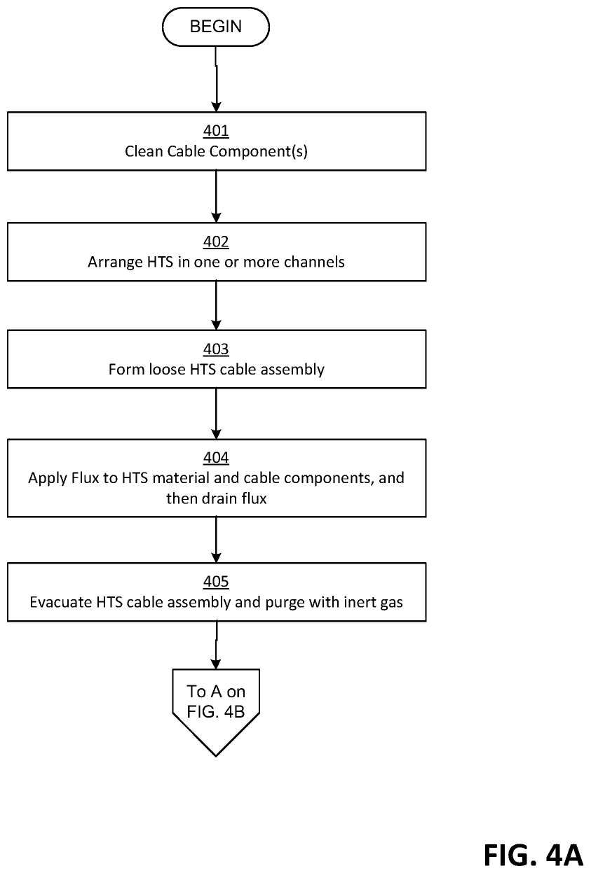

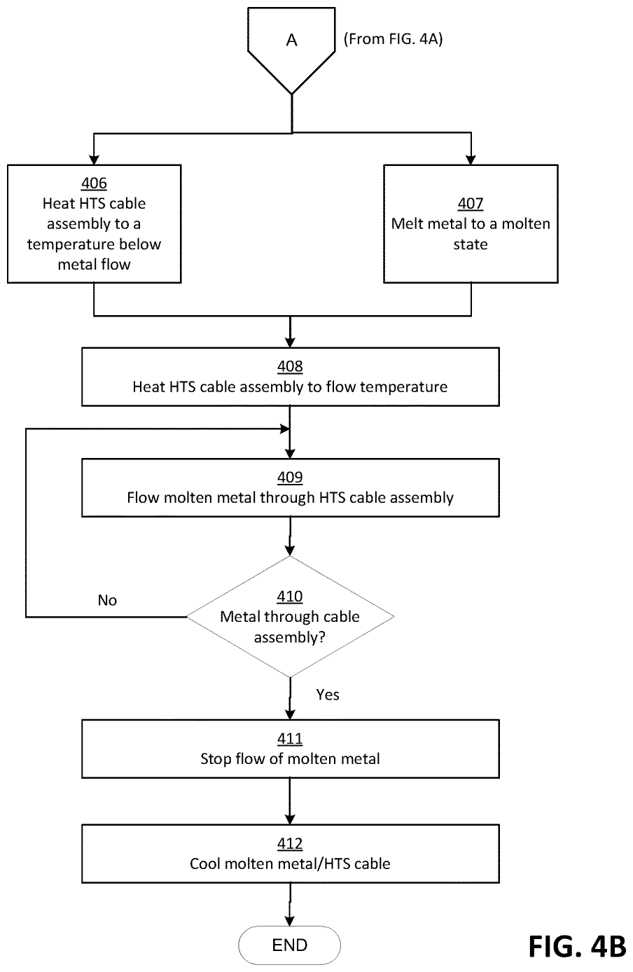

FIGS. 4A-4B are a flow diagram of a method of metal-filling a superconducting cable, according to some embodiments. It should be appreciated that, unless explicitly stated, the processing actions in the flow diagram are unordered meaning that the processing actions listed in the flow diagram may be performed in any convenient order.

Referring now to FIGS. 4A, 4B, an illustrative process for filling an HTS cable (e.g., any of the cables described herein) with a metal (e.g., solder) begins in act 401 by cleaning one or more components of a cable (e.g., any components described above, such as one or more channels of an electrically conductive structure, one or more channels of one or more electrically conductive segments, a channel within a former, HTS materials, jacket, fittings, or combinations thereof) that will undergo a metal-filling process. In some embodiments, act 401 comprises cleaning the one or more cable components by flushing the component(s) with an acidic solution and then rinsing the component(s) with water and/or another liquid. Details of an illustrative example of such a process are described below.

In the below, the material for filling is generally referred to as a “metal” for convenience, although the material need not be a pure metal, and could for instance be a metal alloy. As such, in the below description, references to a “metal” used in the process should be understood to also encompass metal alloys.

As one non-limiting example of cleaning one or more components of a cable, a reservoir comprising a mixture of water and a cleaning solution (e.g., Citronox acidic cleaner) is coupled to a cable former and the water/cleaning solution mixture is pumped or otherwise delivered from the reservoir through the cable former. Subsequently, a rising fluid (e.g., clean water) is pumped through the cable former to rinse the water/cleaning solution mixture out of the cable former. In some cases, the water/cleaning solution mixture and/or the rinsing liquid may be heated to above room temperature (e.g., to 140 °F).

Subsequently to cleaning the component(s) in act 401, HTS material is arranged in one or more channels of an electrically conductive structure, and/or in one or more channels of one or more electrically conductive segments in act 402, thereby producing an arrangement of HTS as described above (e.g., the arrangement of an HTS tape stack 111 within an electrically conductive segment 112 as shown in FIG. 1). In some embodiments, the HTS material arranged in one or more channels in act 402 may comprise one or more stacks of HTS tape. In some embodiments, the HTS tape stack may be pre-tinned to assure a good bond between tapes (e.g., a bond in which tapes are securely coupled together). In some embodiments, the HTS tape stack may be pre-tinned with the metal to be used to fill the cable. In some embodiments, an HTS tape is pre-plated with lead-tin (PbSn) solder (or a lead-tin solder alloy).

In act 403, a so-called “loose HTS cable assembly” (or more simply an “HTS cable assembly”) is formed. The HTS cable assembly is sometimes referred to as a “loose cable assembly” since at least the HTS material (and possibly other components) have not been structurally secured to the channels or other structure which forms part of the HTS cable. The HTS cable assembly may be produced directly as a result of arranging the HTS within one or more channels in act 402, or may be produced as a result of additional steps subsequent to act 402.

As used herein, an “HTS cable assembly” or “loose HTS cable assembly” may refer to a cable structure that comprises an HTS material (e.g., an HTS tape), examples of which are provided herein. For instance, one type of HTS cable assembly comprises HTS material disposed within a channel of a former, with optional additional fittings, etc. In some embodiments, an HTS cable assembly may comprise HTS tape disposed on the bottom of a channel. Although in the above illustrative embodiments the cable former is shown having a circular cross-sectional shape, in other embodiments the former may be provided having a different cross-sectional shape (e.g., an oval cross-sectional shape, a rectangular cross-sectional shape, a square cross-sectional shape or any regular or irregular geometric cross-sectional shape).

At any point before or after HTS material is disposed in the HTS cable assembly (e.g., after HTS material is disposed in a channel of a former or other structure), the HTS cable assembly may be bent into a desired shape (e.g., a coil, a circular shape, a loop or a multi-loop shape).

Returning to FIG. 4A, in act 404 flux is optionally applied to some or all of the HTS material and/or cable components that will form the HTS cable, to remove any oxidation on the surface of the HTS material and/or cable components. In some embodiments, a liquid flux may be applied shortly prior to soldering. Ideally, the flux penetrates all surfaces of the cable components that will be exposed to molten metal, in a manner similar to the subsequent flow of molten metal to be described below. In some embodiments, it has been found that application of liquid flux enables good wetting of solder to tape and cable. In some embodiments, act 404 may comprise applying RMA-5 liquid flux (Indium Corp) and/or Select-10 Flux (Kester) which has lower resin content and corrosivity. It should be appreciated, however, that other liquid fluxes having the same or similar characteristics to RMA-5 liquid flux may also be applied in act 404.

In act 405, the HTS cable assembly is then evacuated (e.g., by arranging the HTS cable assembly in a chamber and evacuating the chamber) and the HTS cable assembly purged with a gas, such as an inert gas. In embodiments in which flux was applied in act 404, any excess flux (e.g., flux which does not adhere to the HTS material or components) may be drained from the assembly as a result of the evacuation in act 405. It has been found however, that any remaining flux may effectively be flushed by the flow of heavier molten metal solder (to be described in conjunction with act 409). As such, an explicit step of draining excess flux may not be required, depending upon how much flux remains in the assembly. In embodiments having long and complex cable geometries, pressurization may be used to drain excess flux. Following fluxing, if used, the cable assembly is again evacuated and purged with an inert gas to remove oxygen which, if present, would interfere with the effective action of the flux when it is heated.

In act 406, the HTS cable assembly is heated to a first temperature. In the case of a pure metal being used for the metal filling process of FIGS. 4A-4B, the first temperature may be selected to be below the melt temperature of the metal. In the case of a metal alloy being used for the metal filling process of FIGS. 4A-4B, the first temperature may be selected to be below the liquidus temperature of the metal alloy.

In some embodiments, act 406 may comprise heating the HTS cable assembly and any associated fittings and piping within an oven, such as a convection oven. This type of heating may provide a degree of uniformity with reduced (and ideally minimal) external temperature control needed and, importantly, reduces (and ideally avoids), the risk of HTS tape temperature exceeding the oven setpoint and causing degradation to that portion of the HTS tape (and hence that portion of the cable) due to exposure to undesirable temperatures.

Either before, after or concurrently with the heating of the cable assembly in act 406, the metal with which the HTS cable assembly will be filled is melted to a liquid state (or a solid/liquid state in the case of an alloy) in act 407. The metal may be melted, for example, using temperature-controlled heaters in a container (also sometimes referred to herein as a can or crucible). Thermocouples inside and/or outside the can may be used to determine when the melting process is complete, and the temperature of the molten metal before flowing. In some embodiments, the metal may be melted inside the oven in which the cable is located but in other embodiments, the metal may be melted separately (e.g., outside the oven). The HTS cable assembly is then heated to a temperature at which the metal will flow in act 408.

One aspect of the metal fill process found to be significant has been obtaining a desirable time-temperature profile. Temperatures need to be high enough for the metal to be fluid with low viscosity, yet result in low enough exposure to avoid thermal degradation, and degradation due to chemical effects of the metal on the HTS material (e.g., a rare earth barium copper oxide (REBCO) tape stack).

In some embodiments for solder filling of an HTS cable comprising an HTS tape stack comprising layers of REBCO tape and using a tin-lead (PbSn) solder, two steps may be performed. First, the oven is set to a temperature that warms the HTS cable assembly, but which does not degrade (or substantially degrade) the HTS tape. In some embodiments, the oven may be set to a temperature below the melt point of the solder disposed on the HTS tapes (e.g., the oven may be set to heat to 185 °C when the process is to fill the cable with a PbSn solder) to thereby greatly reduce, and ideally to avoid, degradation of the HTS tape stack. The heating process is continued until the temperature of the entire cable (or more properly the cable assembly) has reached the set temperature of the oven. The oven set temperature is held at this temperature until a solder supply (e.g., a supply of solder in the can) is fully melted and equilibrated to the process temperature of about 200 °C. Second, the oven temperature may then be set to a temperature which achieves a desired flow temperature of the solder. In embodiments utilizing PbSn solder, the oven temperature may be set to a temperature of about 205 °C and a waiting period occurs until all points on the cable and any associated tubing required for the metal-fill process have achieved a desired flow temperature (e.g., a flow temperature of about 200 °C in the case of PbSn solder) and temperature monitoring is performed to ensure that no point of the HTS cable assembly exceeds a temperature of about 200 °C. In some embodiments, a dwell period may be performed at an intermediate temperature, such at around 194 °C. This approach reduces, and ideally avoids, degradation of the superconducting properties of the HTS tape stack. Once these temperature conditions are met, the metal flow process begins in act 409, and preferably promptly begins so as to reduce, and ideally minimize, the amount of time the HTS tape stack is exposed to such relatively high temperatures (e.g., temperatures above or about 200 °C).

Application and monitoring of a plurality of temperature monitoring devices (e.g., thermocouples) at multiple points in a metal-fill processing station and on the cables may be important to the process, since degradation of some HTS materials (e.g., REBCO) increases exponentially with temperature above 200 °C. The locations of the temperature monitoring devices are selected for each cable geometry. Considerations will include the size and expected thermal uniformity of the cable, and the local measurements which will be needed to guide the planned cooling process. Temperatures may be adjusted for different solders or different types of HTS materials. Such an optimized time-temperature profiles for solder-filling (or more generally, metal-filling) of HTS cables is unique to the process described herein and is one factor leading to the success of the described technique, even when solders such as Sn₆₀Pb₄₀ are used whose melt temperature is high enough to potentially damage HTS.

Alternate solder alloys may also be used which reduce degradation. The choice of suitable solders for a given application will depend on the required properties—including but not limited to mechanical, thermal and electrical, for the application of the cable.

Acts 409 and 410 may be performed as a loop to ensure that molten metal flows through the entire cable assembly in act 409. In some embodiments, the flow of molten metal through the entire cable assembly may be achieved at least partially via gravity (i.e. at atmospheric pressure), via a displacement pump, or using a vacuum-pressure technique.

In act 410, once a decision has been made that sufficient molten metal has flowed through the portion (or portions) of the cable assembly in which the HTS material is disposed, then the flow of molten metal is stopped in act 411 and the molten metal and HTS cable assembly are cooled using one or more cooling devices (act 412), and after cooling is complete a solder-filled (or more generally, metal-filled) HTS cable is resultant. It should be noted that in some embodiments, the flow of molten metal (e.g., solder in a liquid state) does not stop as soon as metal is through cable. Rather, metal flow is not stopped until a predetermined quantity of metal is through the cable and has reached the dump. Flowing additional metal beyond simply filling the cable may be beneficial in removing flux from the cable and/or in reducing the void fraction in the metal-filled cable once the metal returns to a solid state.

In the illustrative method shown in FIGS. 4A and 4B, it will be appreciated that an HTS cable may be formed without performing all processing acts shown in FIGS. 4A, 4B and/or in the specific order presented. As one non-limiting example, depending on cleanliness of the received former, cleaning in act 401 may not be necessary in all instances. Furthermore, in at least some cases some portions of the method might be performed simultaneously. As one non-limiting example, in some cases the application of flux in act 404 may be performed after evacuation of the HTS cable assembly in act 405. As another non-limiting example, in some cases heating the HTS cable assembly in act 406 and melting of the metal in act 407 may be performed concurrently, or either step may be started or even completed prior to the other beginning. In some cases, act of the illustrative method (and/or portions of the acts) shown in FIGS. 4A and 4B may be omitted entirely. For instance, in some embodiments, act 404 in which flux is applied to the HTS material and drained may be omitted. In some embodiments, the purging aspect of act 405 may be omitted while the evacuation aspect of act 404 is performed.

In addition to the process shown in FIGS. 4A-4B and described above, any of the techniques shown or described in PCT Application No. PCT/US2020/060170, filed on Nov. 12, 2020, titled “Processes, Systems and Devices for Metal Filling of High Temperature Superconductor Cables,” which is hereby incorporated by reference in its entirety, may also be employed to produce a superconducting cable as described herein.

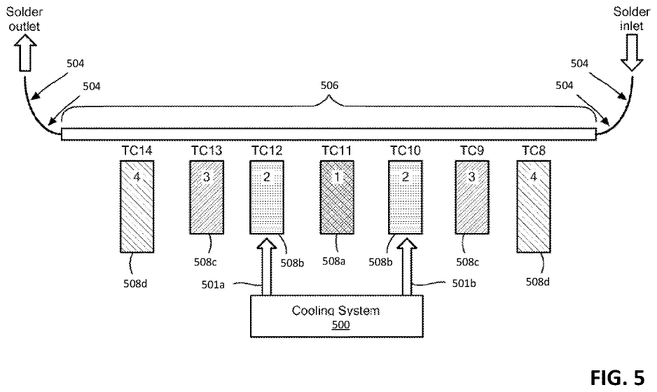

FIG. 5 depicts a cooling system that may be operated to cool an HTS cable assembly, such as in act 412 of the method shown in FIGS. 4A-4B. In the example of FIG. 5, a cooling system 500 includes one or more cooling devices (e.g. blowers or fans or other air moving devices) and one or more movable heating units (e.g. heaters). In the illustrative embodiment of FIG. 5, the cooling system 500 comprises two movable blowers (or fans) as cooling devices, and a pair of heaters. The cooling system is thermally coupled to an HTS cable assembly 506. The one or more end heaters 504 may be thermally coupled to opposing ends of an HTS cable while the two blowers are thermally coupled to the HTS cable assembly 506 but are movable with respect to the HTS cable. In embodiments, the end heaters may be used with or without a cooling system, to maintain liquid solder near the ends as long as possible.

During operation of cooling system 500, cooling starts with the first and second cooling elements directed toward a first region 508a or zone of the HTS cable (identified with reference numeral “1” in FIG. 5 and hereinafter referred to as “zone 1” or “region 1”). A thermocouple (denoted as TC11 in FIG. 5) is disposed in or proximate to Zone 1 of the cable. A thermocouple (denoted as TC10 or TC12 in FIG. 5) is disposed in or proximate to Zone 2 of the cable. Once the thermocouples TC10, TC11 and TC12 indicate that the liquid metal in and adjacent to this section (i.e. Zones 1 and 2 have solidified), the cooling elements are moved or otherwise directed to one or more sections of the cable assembly adjacent Zone 1. In this example, the cooling elements are moved to two sections adjacent to Zone 1 each designated as Zone 2. (identified with reference numeral “2” in FIG. 5 and hereinafter referred to as “Zone 2” or region 2). Once the thermocouples TC9 and TC13 indicates that the molten metal in the next section (i.e. Zone 3) is solid, cooling elements are moved to Zone 3, then Zone 4 and so on and so forth and the process is repeated for each zone. In some embodiments, it may be preferred to locate the thermocouple substantially in the middle of the zone. However, the thermocouple may also be placed in other portions of the zone.

In operation, the cooling elements are initially aimed at a central portion of the cable (and ideally the center of the cable), and temperatures along the cable are monitored (e.g. via the thermocouples or any other suitable means for monitoring temperature). As each region of the cable solidifies (as evident, for example, from a period of constant temperature followed by a decrease in temperature), the cooling elements are moved to that section (or region) to more rapidly cool that section and create a gradient towards the next. Thus, as illustrated in FIG. 5, both cooling elements 501a, 501b are initially directed toward region 1 (i.e. TC11) and are subsequently moved to region 2 (e.g. one cooling element moved to Zone 2 508b and the other moved to Zone 2 508c), then Zone 3 508d, 508d and so on and so forth until each cable region has been cooled. The number of regions used for this process may be adapted to the length of the cable. With this approach, by waiting until a region is solid before cooling adjacent regions, one avoids a risk of ‘trapping’ liquid.

The cooling system and process described in conjunction with FIG. 5 may be suitable for cables having a length greater than about 2 m. This method has been successfully applied to cables up to about 3 m in length and suitable mechanical and electrical performance has been demonstrated in tests at high magnetic field. An upper limit to cable length for this method may be set by cooling due to natural convection and could be increased by increasing the ambient temperature about the HTS cable assembly 506.

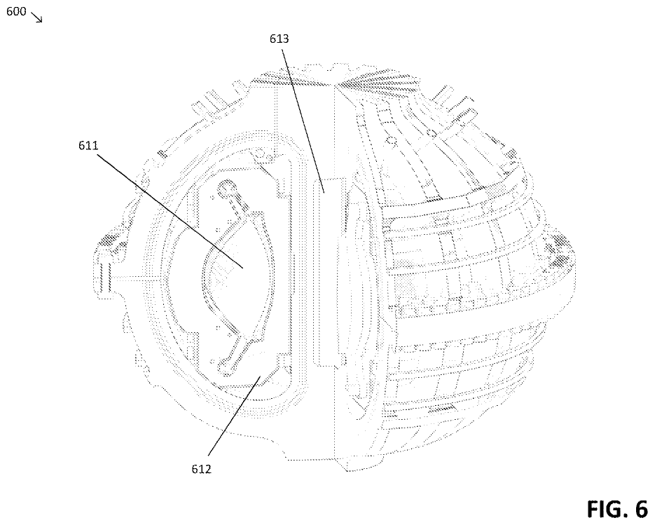

FIG. 6 is a three-dimensional graphic of a fusion machine with a cutaway portion illustrating various components of a tokamak, according to some embodiments. A magnet within a fusion machine may be formed from a superconducting cable as described above. FIG. 6 shows a partial cross-section through a fusion machine 600 and includes a magnet coil 613, which is fabricated from, or otherwise includes, a superconducting cable as described above, a neutron shield 612, and a core region 611. According to some embodiments, the magnet coil 613 may be, or may form part of, a central solenoid and/or other poloidal field solenoidal coils.

Persons having ordinary skill in the art may appreciate other embodiments of the concepts, structures, processes, results, and techniques disclosed herein. It is appreciated that superconducting cables configured according to the concepts, structures, processes and techniques described herein may be useful for a wide variety of applications, including applications in which the superconducting cable is wound into a coil to form a magnet. For instance, one such application is conducting nuclear magnetic resonance (NMR) research into, for example, solid state physics, physiology, or proteins, for which such cables may be wound into a magnet. Another application is performing clinical magnetic resonance imaging (MRI) for medical scanning of an organism or a portion thereof, for which compact, high-field magnets are needed. Yet another application is high-field MRI, for which large bore solenoids are required. Still another application is for performing magnetic research in physics, chemistry, and materials science. Further applications is in magnets for particle accelerators for materials processing or interrogation; electrical energy generators; medical accelerators for proton therapy, radiation therapy, and radiation generation generally; superconducting energy storage; magnetohydrodynamic (MHD) electrical generators; and material separation, such as mining, semiconductor fabrication, and recycling. It is appreciated that the above list of applications is not exhaustive, and there are further applications to which the concepts, structures, processes, and techniques disclosed herein may be put without deviating from their scope.

Having thus described several aspects of at least one embodiment of the disclosed concepts, structures, processes, and techniques, it is to be appreciated that various alterations, modifications, and improvements will readily occur to those skilled in the art.

Such alterations, modifications, and improvements are intended to be part of this disclosure, and are intended to be within the spirit and scope of the concepts, structures, processes, and techniques described herein. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the concepts, structures, processes, and techniques described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments. Other illustrative aspects include:

Aspect 1. A cable comprising: an electrically conductive structure extending along the cable and comprising a channel, the channel comprising a primary channel portion and a side-channel portion in fluid communication with or otherwise coupled or connected to and arranged alongside the primary channel portion; a stack of high temperature superconductor (HTS) tapes arranged within the primary channel portion of the channel; and solder arranged within the side-channel portion of the channel and within at least part of the primary channel portion of the channel.

Aspect 2. The cable of aspect 1, wherein the solder in the at least part of the primary channel portion of the channel and the solder in the side-channel portion of the channel form a contiguous region of solder.

Aspect 3. The cable of aspect 1, wherein an opening between the primary channel portion and the side-channel portion of the channel is smaller than the stack of HTS tapes.

Aspect 4. The cable of aspect 1, further comprising a metal jacket surrounding the electrically conductive structure, and wherein the side-channel portion of the channel extends at least partially into the metal jacket.

Aspect 5. The cable of aspect 1, wherein the electrically conductive structure comprises a plurality of channels each comprising a respective stack of HTS tapes.

Aspect 6. The cable of aspect 1, wherein the electrically conductive structure is one of a plurality of electrically conductive segments that extend along the cable and that each comprise a respective channel in which a stack of HTS tapes is arranged.

Aspect 7. The cable of aspect 6, wherein none of the plurality of electrically conductive segments directly contact any of the other electrically conductive segments.

Aspect 8. The cable of aspect 6, wherein the plurality of electrically conductive segments exhibit radial symmetry around a central axis of the cable.

Aspect 9. The cable of aspect 8, wherein the plurality of electrically conductive segments are twisted around the central axis of the cable, and wherein the stack of HTS tapes follow a helical path around the central axis.

Aspect 10. The cable of aspect 6, further comprising an electrically insulating material arranged between adjacent electrically conductive segments of the plurality of electrically conductive segments that electrically insulates the plurality of electrically conductive segments from one another.

Aspect 11. The cable of aspect 1, wherein the cable further comprises at least one interior cooling channel.

Aspect 12. The cable of aspect 6, wherein the plurality of electrically conductive segments comprise copper.

Aspect 13. The cable of aspect 1, wherein the stack of HTS tapes comprise a rare earth barium copper oxide superconductor.

Aspect 14. A method comprising: at least partially filling a channel of a high temperature superconductor (HTS) cable assembly with a molten metal, the HTS cable assembly comprising: an electrically conductive structure extending along the HTS cable assembly and comprising the channel, the channel comprising a primary channel portion and a side-channel portion connected to and arranged alongside the primary channel portion; and a stack of high temperature superconductor (HTS) tapes arranged within the primary channel portion of the channel, wherein at least partially filling the channel comprises directing the molten metal into the side-channel portion of the channel and into the primary channel portion of the channel; and operating one or more cooling devices to cool the molten metal in the channel.

Aspect 15. The method of aspect 14, wherein the HTS cable assembly comprises a former in which the channel is arranged.

Aspect 16. The method of aspect 15, wherein the former comprises four channels each comprising an HTS, and wherein the method comprises at least partially filling the four channels of the former.

Aspect 17. The method of aspect 16, wherein HTS cable assembly further comprises a jacket arranged around the former.

Aspect 18. The method of aspect 14, comprising completely filling the at least one channel of the HTS cable assembly.

Aspect 19. The method of aspect 15, wherein at least partially filling the channel of the HTS cable assembly with a molten metal comprises: heating the HTS cable assembly; and applying pressure to the molten metal so as to force the molten metal through the channel of the former.

Aspect 20. The method of aspect 19, wherein the molten metal is held by a container, and wherein applying pressure to the molten metal comprises applying pressure to the molten metal within the container.

Aspect 21. The method of aspect 14, wherein the molten metal comprises a PbSn solder.

Aspect 22. A cable comprising: an electrically conductive structure extending along the cable and comprising a channel, the channel comprising a primary channel portion and a secondary portion; a stack of high temperature superconductor (HTS) tapes arranged within the primary channel portion of the channel; and solder arranged within the secondary portion of the channel and within at least part of the primary channel portion of the channel.

Aspect 23. The cable of aspect 22, wherein the solder in the at least part of the primary channel portion of the channel and the solder in the secondary portion of the channel form a contiguous region of solder.

Aspect 24. The cable of aspect 23, wherein an opening between the primary channel portion and the secondary portion of the channel is smaller than the stack of HTS tapes.

Aspect 25. A cable comprising: an electrically conductive structure extending along the cable and comprising a channel, the channel comprising a primary channel portion; a jacket structure arranged at least partially around the electrically conductive structure, the jacket structure comprising a side-channel portion connected to and arranged alongside the primary channel portion of the electrically conductive structure; a stack of high temperature superconductor (HTS) tapes arranged within the primary channel portion of the channel; and solder arranged within the side-channel portion of the jacket structure and within at least part of the primary channel portion of the channel.

Aspect 26. The cable of aspect 25, wherein the solder in the at least part of the primary channel portion of the channel and the solder in the side-channel portion of the channel form a contiguous region of solder.

Aspect 27. The cable of aspect 26, wherein an opening between the primary channel portion and the side-channel portion of the channel is smaller than the stack of HTS tapes.

Also, the described concepts, structures, processes, and techniques may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A cable comprising:
an electrically conductive structure extending along the cable and comprising a channel, the channel comprising a primary channel portion and a side-channel portion connected to and arranged alongside the primary channel portion;
a stack of high temperature superconductor (HTS) tapes arranged within the primary channel portion of the channel; and
solder arranged within the side-channel portion of the channel and within at least part of the primary channel portion of the channel.

2. The cable of claim 1, wherein the solder in the at least part of the primary channel portion of the channel and the solder in the side-channel portion of the channel form a contiguous region of solder.

3. The cable of claim 1, wherein an opening between the primary channel portion and the side-channel portion of the channel is smaller than the stack of HTS tapes.

4. The cable of claim 1, further comprising a metal jacket surrounding the electrically conductive structure, and wherein the side-channel portion of the channel extends at least partially into the metal jacket.

5. The cable of claim 1, wherein the electrically conductive structure comprises a plurality of channels each comprising a respective stack of HTS tapes.

6. The cable of claim 1, wherein the electrically conductive structure is one of a plurality of electrically conductive segments that extend along the cable and that each comprise a respective channel in which a stack of HTS tapes is arranged.

7. The cable of claim 6, wherein none of the plurality of electrically conductive segments directly contact any of the other electrically conductive segments.

8. The cable of claim 6, wherein the plurality of electrically conductive segments exhibit radial symmetry around a central axis of the cable.

9. The cable of claim 8, wherein the plurality of electrically conductive segments are twisted around the central axis of the cable, and wherein the stack of HTS tapes follow a helical path around the central axis.

10. The cable of claim 6, further comprising an electrically insulating material arranged between adjacent electrically conductive segments of the plurality of electrically conductive segments that electrically insulates the plurality of electrically conductive segments from one another.

11. The cable of claim 1, wherein the cable further comprises at least one interior cooling channel.

12. The cable of claim 6, wherein the plurality of electrically conductive segments comprise copper.

13. The cable of claim 1, wherein the stack of HTS tapes comprise a rare earth barium copper oxide superconductor.

14. A method comprising:
at least partially filling a channel of a high temperature superconductor (HTS) cable assembly with a molten metal, the HTS cable assembly comprising:
an electrically conductive structure extending along the HTS cable assembly and comprising the channel, the channel comprising a primary channel portion and a side-channel portion connected to and arranged alongside the primary channel portion; and
a stack of HTS tapes arranged within the primary channel portion of the channel,
wherein at least partially filling the channel of the HTS cable assembly comprises directing the molten metal into the side-channel portion of the channel and into the primary channel portion of the channel; and
operating one or more cooling devices to cool the molten metal in the channel.

15. The method of claim 14, wherein the HTS cable assembly comprises a former in which the channel is arranged.

16. The method of claim 15, wherein the former comprises four channels each comprising an HTS, and wherein the method comprises at least partially filling the four channels of the former.

17. The method of claim 16, wherein HTS cable assembly further comprises a jacket arranged around the former.

18. The method of claim 14, comprising completely filling the at least one channel of the HTS cable assembly.

19. The method of claim 15, wherein at least partially filling the channel of the HTS cable assembly with a molten metal comprises:
heating the HTS cable assembly; and
applying pressure to the molten metal so as to force the molten metal through the channel of the former.

20. The method of claim 19, wherein the molten metal is held by a container, and wherein applying pressure to the molten metal comprises applying pressure to the molten metal within the container.

21. The method of claim 14, wherein the molten metal comprises a PbSn solder.

22. A cable comprising:
an electrically conductive structure extending along the cable and comprising a channel, the channel comprising a primary channel portion and a secondary portion;
a stack of high temperature superconductor (HTS) tapes arranged within the primary channel portion of the channel; and
solder arranged within the secondary portion of the channel and within at least part of the primary channel portion of the channel.

23. The cable of claim 22, wherein the solder in the at least part of the primary channel portion of the channel and the solder in the secondary portion of the channel form a contiguous region of solder.

24. The cable of claim 23, wherein an opening between the primary channel portion and the secondary portion of the channel is smaller than the stack of HTS tapes.

25. A cable comprising:
an electrically conductive structure extending along the cable and comprising a channel, the channel comprising a primary channel portion;
a jacket structure arranged at least partially around the electrically conductive structure, the jacket structure comprising a side-channel portion connected to and arranged alongside the primary channel portion of the electrically conductive structure;
a stack of high temperature superconductor (HTS) tapes arranged within the primary channel portion of the channel; and
solder arranged within the side-channel portion of the jacket structure and within at least part of the primary channel portion of the channel.

26. The cable of claim 25, wherein the solder in the at least part of the primary channel portion of the channel and the solder in the side-channel portion of the channel form a contiguous region of solder.

27. The cable of claim 26, wherein an opening between the primary channel portion and the side-channel portion of the channel is smaller than the stack of HTS tapes.

28. A high temperature superconductor (HTS) cable assembly comprising:
at least one electrically conductive structure extending along the cable and comprising a primary channel portion and a side-channel portion with an opening between the primary channel portion and side-channel portion such that the primary channel portion and the side-channel portion are in fluid communication; and
a stack of HTS tapes arranged within the primary channel portion with at least a portion of the stack of HTS proximate the opening between the primary channel portion and side-channel portion.

29. The HTS cable assembly of claim 28, wherein a size of the opening between the primary channel portion and the side-channel portion is selected such that the stack of HTS tapes will not move into the side-channel portion.

30. The HTS cable assembly of claim 28, further comprising a metal jacket disposed about the at least one electrically conductive structure.

31. The HTS cable assembly of claim 28, wherein the at least one electrically conductive structure is provided as a plurality of electrically conductive structures, each of the plurality of electrically conductive structures corresponding to an electrically conductive segment, each of plurality of electrically conductive segments having a shape which defines a primary channel portion and a side-channel portion; and
a plurality of stacks of HTS tapes, each of the plurality of stacks of HTS tapes disposed in a respective one of the primary channel portions.

32. The HTS cable assembly of claim 31, further comprising an insulator disposed between adjacent ones of the plurality of electrically conductive segments, the insulator having a size and shape selected to electrically insulate the plurality of electrically conductive segments from one another.

33. The HTS cable assembly of claim 31 wherein:
the plurality of electrically conductive segments are disposed about a central longitudinal axis of the HTS cable assembly; and
the stack of HTS tapes follow a helical path around the central longitudinal axis of the HTS cable assembly.

34. The HTS cable assembly of claim 31, further comprising an electrically insulating material arranged between adjacent electrically conductive segments of the plurality of electrically conductive segments that electrically insulates the plurality of electrically conductive segments from one another.
